(19) United States
(12) Patent Application Publication
(10) Pub. No.: US 2020/0193510 A1
(43) Pub. Date: Jun. 18, 2020

(54) SYSTEM AND METHOD FOR AN ENTERPRISE HYBRID AND ONLINE AUCTION PLATFORM

(71) Applicant: Sotheby's, Inc., New York, NY (US)

(72) Inventors: Michael ZOLFO, Mount Kisco, NY (US); Olafur STEPHENSEN, Brooklyn, NY (US); Miles Gavin MENG, New York, NY (US); Lauren LEE, New York, NY (US)

(73) Assignee: Sotheby's, Inc., New York, NY (US)

(21) Appl. No.: 16/717,485

(22) Filed: Dec. 17, 2019

Related U.S. Application Data
(60) Provisional application No. 62/780,749, filed on Dec. 17, 2018.

(51) Int. Cl. G06Q 30/08; G06Q 20/32; H04L 29/06; G06F 16/23; G06F 3/0346

(52) U.S. Cl. CPC G06Q 30/08; G06Q 20/3224; G06F 3/0346; G06F 16/2358; H04L 63/102

(57) ABSTRACT

The present disclosure generally relates to the technical field of auction platforms and enterprise information systems. More specifically, the present disclosure is directed to systems and methods for implementing a hybrid and online auction platform that permits auctioneer-less live auctions and enhances user experience. According to various, embodiments, the system comprises a computing device configured to: communicatively couple at least one client device that is accessible by a user having a respective user profile to a server hosting an auction; receive a request to associate a user profile with the auction hosted by the server; receive via the at least one client device bidding information associated with the auction, wherein the bidding information is dynamically displayed on the graphical user interface of the client device; transmit bidding information from a respective user of the at least one client device associated with the auction; and wherein the auction is configured to receive live bid information from bidders in an auction house.

### PRIORITY

The present application claims the priority of U.S. Provisional Application No. 62/780,749 filed Dec. 17, 2018, the disclosure of which is incorporated herein by reference.

### FIELD

The present disclosure generally relates to the technical field of auction platforms and enterprise information systems. More specifically, the present disclosure is directed to systems and methods for implementing a hybrid and online auction platform that permits auctioneer-less live auctions and enhances user experience.

### BACKGROUND

The auction industry is growing at a rapid pace since the rise of auction-style commerce through the internet. Concurrently, there is a persistent desire across the industry to actively integrate traditional onsite auctions with online auctions occurring electronically through the internet. When integrating an online auction with an onsite auction, the integrity and efficiency of the onsite auction is paramount. Specifically, the onsite auction should not negatively impact the sale of objects being consigned with an auction house through traditional means. Any degradation in efficiency of an auction being conducted live at the auction house would decrease the potential sale value of an item.

Traditional methods of incorporating a live onsite auction with an online auction have various drawbacks. For example, the integration of systems between online auction sites such eBay™, Amazon™, etc., utilize varying technology to associate an online user with an auction. Moreover, these systems are designed to facilitate a strictly online auction. Integration of online auction sites with live traditional live auctions typically require integration of both technology and authentication systems which may affect efficiency. An additional drawback is that the live auction system and the online auction system may not be integrated. For example, a live auction typically requires an auctioneer facilitating live in person bids for an item available at the auction. Integrating an online system with the live auction would require an additional person to co-facilitate the auction with the auctioneer such that a plurality of bids received from the online and live auctions are incorporated with each other. Integration in this manner negatively impacts the efficiency of the auction by deterring participation and/or reducing confidence in the auction process integrity.

The present disclosure describes, in various embodiments, a hybrid auction platform used for the sale of objects consigned with an auction house that addresses the limitations described above. The system described herein, permits a wide variety of bidding options, including bidding on objects in a live auction as well as online, so that a bidder does not need to he physically present in an auction house or auction location to bid on items available for purchase. In some embodiments, the system described herein is able to conduct an auctioneer-less live auction. In various embodiments, the system is able to use wayfinding systems to provide an enhanced experience within the auction location to notify users when an auction begins, when a lot is scheduled to go up for sale, where it is in the building, and recommendations to the user on potential purchases.

The present disclosure permits users on a computer or mobile device to submit bids in an online auction. In some embodiments, the system uses automation to capture and process users' bids against pre-set auction configurations. In various embodiments, the system provides a fully automated online auction experience in real-time, without the need for a clerking console or a human administrator (i.e. “auctioneer”) to run the auction.

According to various embodiments, the systems and methods described herein allow for real-time bidding updates to be sent to the end-user, as well as updates sent in real-time to front-end devices to allow users to see status or the lot, whether reserve has been met, what the current leading bid for the object is, how much time is left in the auction, and what the next bidding increment would be.

### SUMMARY

According to various embodiments of the present disclosure, a system is disclosed. The system comprises a computing device configured to: communicatively couple at least one client device that is accessible by a user having a respective user profile to a server hosting an auction; receive a request to associate a user profile with the auction hosted by the server; receive via the at least one client device bidding information associated with the auction, wherein the bidding information is dynamically displayed on the graphical user interface of the client device; transmit bidding information from a respective user of the at least one client device associated with the auction; and wherein the auction is configured to receive live bid information from bidders in an auction house.

According to various embodiments of the present disclosure, a non-transitory computer readable medium having instructions stored thereon is disclosed. The non-transitory computer readable medium wherein the instructions, when executed by the processor cause a device to perform operations comprising: communicatively couple at least one client device that is accessible by a user having a respective user profile to a server hosting an auction; receive a request to associate a user profile with the auction hosted by the server; receive via the at least one client device bidding information associated with the auction, wherein the bidding information is dynamically displayed on the graphical user interface of the client device; transmit bidding information from a respective user of the at least one client device associated with the auction; and wherein the auction is configured to receive live bid information from bidders in an auction house without an operator.

According to various embodiments of the present disclosure, a method is disclosed. The method comprises the steps of communicatively coupling at least one client device that is accessible by a user having a respective user profile to a server hosting an auction; receiving a request to associate a user profile with the auction hosted by the server; receiving via the at least one client device bidding information associated with the auction, wherein the bidding information is dynamically displayed on the graphical user interface of the client device; transmitting bidding information from a respective user of the at least one client device associated with the auction; receiving live bid information from bidders in an auction house; and integrating live bid information and bidding information from the at least one client device into the auction automatically.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, in which:

FIG. 1A illustrates one example of a system in accordance with some embodiments of the present disclosure.

FIG. 1B illustrates one example of an architecture of a mobile device in accordance with some embodiments of the present disclosure.

FIG. 2 illustrates an example of management server components in accordance with some embodiments of the present disclosure.

FIG. 3 is a flow diagram illustrating an example bidding process in accordance with some embodiments of the present disclosure.

FIG. 4 is a flow diagram illustrating an example user bidding process in accordance with some embodiments of the present disclosure.

FIG. 5 illustrates an example auction engine logic for supporting bid type optionality in accordance with some embodiments of the present disclosure,

FIG. 6 is a flow diagram illustrating an example auctioneer-less live auction process in accordance with some embodiments of the present disclosure.

FIG. 7 is a flow diagram illustrating an example smart auction house process in accordance with some embodiments of the present disclosure.

FIG. 8 illustrates example database tables in accordance with some embodiments of the present disclosure.

FIG. 9 illustrates an example user/client information table in accordance with some embodiments of the present disclosure.

FIG. 10 is an example of an Auction Administrator interface in accordance with some embodiments of the present disclosure.

FIG. 11A is an example of a lot detail interface for a client device in accordance with some embodiments of the present disclosure.

FIG. 11B is an example of an auction catalog interface in accordance with some embodiments of the present disclosure,

FIG. 12 is an example of a seller's console interface in accordance with some embodiments of the present disclosure.

FIG. 13 is an example of a saleroom console interface in accordance with some embodiments of the present disclosure.

### DETAILED DESCRIPTION

This description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

As used herein, use of a singular article such as “a,” “an” and “the” is not intended to exclude pluralities of the article's object unless the context clearly and unambiguously dictates otherwise.

A comprehensive hybrid and online auction system and method are provided in the present disclosure. As discussed throughout this specification, the auction system advantageously provides hybrid and online bidding optionality. The system and method advantageously provide a unified system capable of seamlessly incorporating a wide variety of bidding optionality. More specifically, embodiments of the present invention provide for auctioneer-less live auctions and wayfinding systems within an auction location.

### System Overview

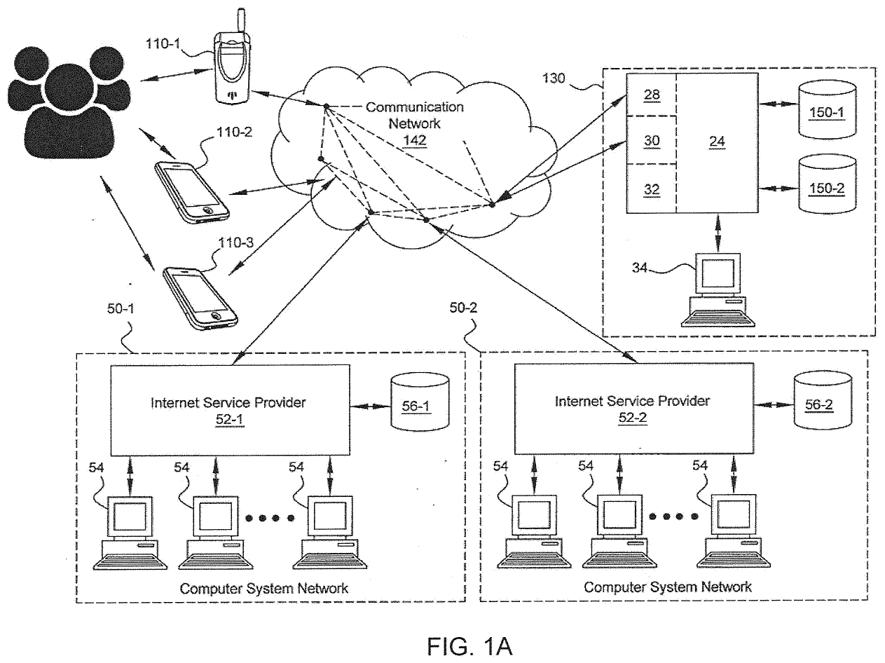

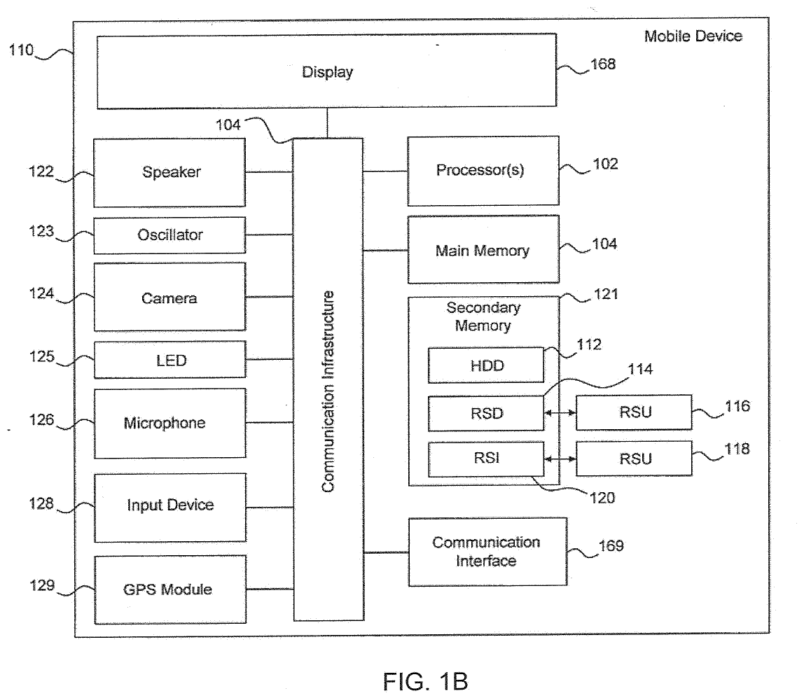

In various embodiments, the auction system may interact with client devices for information exchange. FIG. 1A depicts one example of a system 100 in which a plurality of client devices 110-1, 110-2, and 110-3 (collectively “client devices 110”) are connected via communication network 142 to one or more computer system networks 50-1, 50-2 (“computer networks 50”), and to management server 130. Communication network 142 may be a wide area network (“WAN”), a local area network (“LAN”), personal area network (“PAN”), or the like, In one embodiment, communication network 142 is the Internet and client devices 110 are online. “Online” may mean connecting to or accessing source data or information from a location remote from other devices or networks coupled to communication network 142.

Management server 130 includes a processing unit 24 coupled to one or more data storage units 150-1, 150-2 (collectively referred to as “database management system 150” or “DBMS 150”). The processing unit 24, in some embodiments is configured to provide front-end graphical user interfaces (“GUI”) (e.g., auction interface GUI 28 and client users GUI 30), and a back-end or administrative graphical user interface or portal 32 to one or more remote computers 54 or to one or more local computers 34. In some embodiments, an auction interface, described in further detail below, is provided that accesses management server 130 via GUI 28. The GUIs can take the form of, for example, a webpage that is displayed using a browser program local to remote computers 54 or to one or more local computers 34. It is understood that the system 100 may be implemented on one or more computers, servers, or other computing devices. In some embodiments, the GUI may be displayed on client devices 110 via a software application. For example, system 100 may include additional servers programmed or partitioned based on permitted access to data stored in DBMS 150. As used herein, “portal” is not limited to general-purpose Internet portals, such as YAHOO! ™ or GOOGLE™ but also includes GUIs that are of interest to specific, limited audiences and that provide the party access to a plurality of different kinds of related or unrelated information, links and tools as described below. “Webpage” and “website” may be used interchangeably herein.

Remote computers 54 may be part of a computer system network 50-1, 50-2 and gain access to communication network 142 through an Internet service provider (“TSP”) 52-1, 52-2 (“ISPs 52”). Client devices 110 may gain access to communications network 142 through a wireless cellular communication network, a WAN hotspot, or through a wired or wireless connection with a computer as will be understood by one skilled in the art. Auction facilitators, client users and administrative personnel, as will be described below, may use remote computers 54 and/or client devices 110 to gain access to system 100.

In one embodiment, client devices 110 includes any mobile device capable of transmitting and receiving wireless signals. Examples of mobile instruments include, but are not limited to, mobile or cellular phones, smart phones. personal digital assistants (“PDAs”), laptop computers, tablet computers, music players, and e-readers, to name a few possible devices.

FIG. 1B is a block diagram of one example of an architecture of client device 110. As shown in FIG. 1B, client device 110 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary client device 110. After reading this description, it will be apparent to one of ordinary skill in the art how to implement the method using client devices 110 that include other systems or architectures. One of ordinary skill in the art will understand that computers 34, 54 may have a similar and/or identical architecture as that of client devices 110. Put another way, computers 34, 54 can include some, all, or additional functional components as those of the client device 110 illustrated in FIG. 1B.

Client device 110 includes a display 168 that displays graphics, video, text, and other data received from the communication infrastructure 104 (or from a frame buffer not shown) to a user (e.g., a subscriber, commercial user, back-end user, or other user). Examples of such displays 168 include, but are not limited to, LCD screens, OLED display, capacitive touch screen, and a plasma display, to list only a few possible displays. Client device 110 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114, As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into client device 110. Such devices may include, for example, a removable storage unit (“RSU”) 118 and a corresponding interface (“RSI”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to client device 110.

Client device 110 may also include a speaker 122, an oscillator 123, a camera 124, a light emitting diode (“LED”) 125, a microphone 126, an input device 128, an accelerometer (not shown), and a global positioning system (“GPS”) module 129, Examples of input device 128 include, but are not limited to, a keyboard, buttons, a trackball, or any other interface or device through which a user may input data. In some embodiment, input device 128 and display 168 are integrated into the same device. For example, display 168 and input device 128 may be touchscreen through which a user uses a finger, pen, and/or stylus to input data into client device 110.

Client device 110 also includes one or more communication interfaces 169, which allows software and data to be transferred between client device 110 and external devices such as, for example, another client device 110, a computer 34, 54 and other devices that may be locally or remotely connected to system 100. Examples of the one or more communication interfaces 169 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 169 may also include a wireless interface configured for short range communication, such as near field communication (“NEC”), Bluetooth, or other interface for communication via another wireless communication protocol. As briefly noted above, one of ordinary skill in the art will understand that computers 34, 54 and portions of system 100 may include some or all components of client device 110.

Software and data transferred via the one or more communications interfaces 169 are in the form of signals, which may be electronic, electromagnetic, optical, or other signals capable of being received by communications interfaces 169. These signals are provided to communications interface 169 via a communications path or channel. The channel may be implemented using wire or cable, fiber optics, a telephone line, a cellular link, a radio frequency (“RE”) link, or other communication channels.

In this document, the terms “non-transitory computer program medium” and “non-transitory computer readable medium” refer to media such as removable storage units 116, 118, or a hard disk installed in hard disk drive 112. These computer program products provide software to client device 110. Computer programs (also referred to as “computer control logic”) may be stored in main memory 108 and/or secondary memory 110. Computer programs may also be received via the one or more communications interfaces 169. Such computer programs, when executed by a processor(s) 102, enable the client device 110 to perform the features of the method discussed herein.

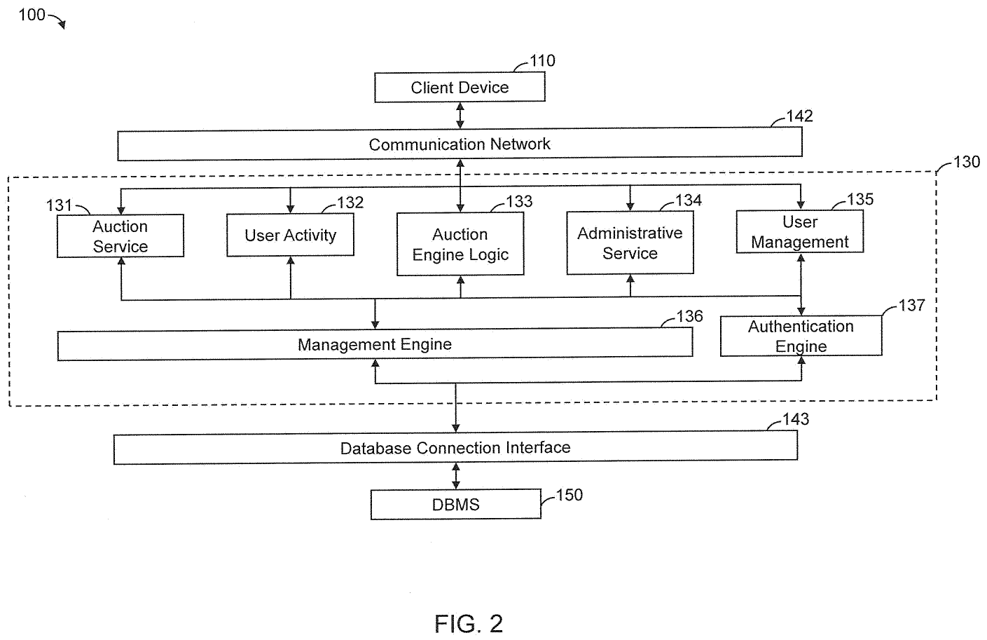

FIG. 2 illustrates an example of management server components in accordance with some embodiments of the present disclosure. As shown in FIG. 2, system 100 may he a computing environment including one or more client devices 110, management server 130, one or more software management modules 131, 132, 133, 134, and 135, one or more software engines 136 and 137, database connection interface 1143, database management system 150, and a communication network 142 connecting various components of system 100. Although one client device 110 is described, any number of client devices may be present. In various embodiments, client device 110 is a user device capable of connecting to the Internet or similar network as will be described below. In some embodiments, at least one device is a bidder client device 1104 and an auction system host client device 110-2.

In various embodiments, as shown in FIGS. 1A-1B, client device 110 may include a computing device such as a hashing computer, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), or any other suitable computing device configured to store data and software instructions, execute software instructions to perform operations, and/or display information on a display device. Client device 110 may be associated with one or more users (not shown). For example, a user operates client device 110, causing it to perform one or more operations in accordance with various embodiments.

Client device 110 includes one or more tangible, non-transitory memories that store data and/or software instructions, and one or more processors configured to execute software instructions. Client device 110 may include one or more display devices that display information to a user and one or more input devices (e.g., keypad, keyboard, touchscreen, voice activated control technologies, or any other suitable type of known input device) to allow the user to input information to the client device. Client device 110 processor(s) may be any central processing unit (“CPU”), microprocessor, micro-controller, or computational device or circuit for executing instructions. Processor(s) are connected to a communication infrastructure (e.g., a communications bus, cross-over bar, or network). Various software embodiments are described in terms of this exemplary client device 110. After reading this description, it will be apparent to one of ordinary skill in the art how to implement the method using client device 110 that include other systems or architectures. One of ordinary skill in the art will understand that computers may have a similar and/or identical architecture as that of client device 110. Put another way, computers can include some, all, or additional functional components as those of the client device 110 illustrated in FIGS. 1A-1B.

Client device 110 also includes one or more communication interfaces 169, which allows software and data to be transferred between client device 110 and external devices such as, for example, another client device 110, a computer, management server 130, and other devices that may be locally or remotely connected to client device 110. Examples of the one or more communication interfaces may include, but are not limited to, a modem, a network interface (e.g., communication interface 169, such as an Ethernet card or wireless card), a communications port, a Personal Computer Memory Card International Association (“PCMCIA”) slot and card, one or more Personal Component Interconnect (“PCI”) Express slot and cards, or any combination thereof The one or more communication interfaces 169 may also include a wireless interface configured for short range communication, such as near field communication (“NEC”), Bluetooth, or other interface for communication via another wireless communication protocol.

Software and data transferred via the one or more communications interfaces 169 are in the form of signals, which may be electronic, electromagnetic, optical, or other signals capable of being received by communications interfaces. These signals are provided to communications interface 169 via a communications path or channel. The channel may be implemented using wire or cable, fiber optics, a telephone line, a cellular link, a radio frequency (“RF”) link, or other communication channels.

In an embodiment where the system 100 or method is partially or entirely implemented using software, the software may be stored in a computer program product and loaded into client device 110 using removable storage drive, hard drive, and/or communications interface. The software, when executed by processor(s), causes the processor(s) to perform the functions of the method described herein. In another embodiment, the method is implemented primarily in hardware using, for example, hardware components such as application specific integrated circuits (“ASICs”). implementation of the hardware state machine so as to perform the functions described herein will be understood by persons skilled in the art. In yet another embodiment, the method is implemented using a combination of both hardware and software.

Embodiments of the subject matter described in this specification can be implemented in a system 100 that includes a back end component, e.g., as a data server, or that includes a middleware component, e.g., an application server, or that includes a front end component (e.g., a client device 110) having a graphical user interface or a Web browser through which a user can interact with an implementation of the subject matter described is this specification, or any combination of one or more such back end, middleware, or front end components. The components of the system can be interconnected by any form or medium of digital data communication, (e.g., a communication network 142). Communications network 142 may include one or more communication networks or media of digital data communication. Examples of communication network 142 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet and combinations thereof. In accordance with various embodiments of the present disclosure, communications network 142 may include the Internet and any publicly accessible network or networks interconnected via one or more communication protocols, including, but not limited to, hypertext transfer protocol (HTTP) and HyperText Transfer Protocol Secured (HTTPS) and Secured Socket Layer/Transport Layer Security (SSL/TLS) and transmission control protocol/internet protocol (TCP/IP). Communications protocols in accordance with various embodiments also include protocols facilitating data transfer using radio frequency identification (RFD) communications and/or NFC. Moreover, communications network 142 may also include one or more mobile device networks, such as a GSM or LTE network or a PCS network, allowing a client device to send and receive data via applicable communications protocols, including those described herein. For ease of illustration, communication network 142 is shown as an extension of management server 130.

A client device 110 and server 130 are generally remote from each other and typically interact through a communication network 142. The relationship of client device 110 and management server 130 arises by virtue of computer programs running on the respective system components and having a client-server relationship to each other. System 100 may include a web/application server (not shown) in embodiments used to gain access to many services provided by management server 130.

In one aspect, client device 110 stores in memory one or more software applications that run on the client device and are executed by the one or more processors. In some instances, each client device stores software applications that, when executed by one or more processors, perform operations that establish communications with management server 130 (e.g., across communication network 142 via communication interface 169) and that obtain, from management server 130, information or data via database management system 150 in accordance with various embodiments.

In various embodiments, client device 110 may execute stored software application(s) to interact with management server 130 via a network connection. The executed software applications may cause client device 110 to communicate information (e.g., bidding information, lot information, auction information, etc.). As described below, executed software applications (s) may be configured to allow a user associated with client device 110 to initiate a bid associated with a hybrid or online auction. Stored software application(s) on client device 110 are configured to access webpages on the Internet or other suitable network based communication capable of interacting with communication network 142, as would be understood by one of ordinary skill in the art. For example, a user may access a user account on management server 130 via an Internet webpage. in this example, management server 130 is configured to render the Internet webpage for the user on client device 110. Alternatively, management server 130 may provide information to stored software application(s) on client device 110 via communication network 142. In this example, client device 110 will display information provided by management server 130 using a stored software application(s) graphical user interface display. In the example above, a respective user account may be associated with a developer, client user, or supervisor/monitoring authority as would be understood by one of ordinary skill in the art and described below.

According to various embodiments, system 100 includes database management system/storage 150 for managing and storing data, for example, auction related information (e.g., bidder information, item/sale information, auction characteristic information, etc.), wayfinding service information, and other data maintained by the management server 1130. The database management system and/or storage are referred to herein simply as DBMS 150 for convenience. DBMS 150 is communicatively coupled with various modules and engines as illustrated in FIGS. 1A-1B.

It should be understood that various forms of data storage or repositories can be used in system 100 that may be accessed by a computing system, such as hard drives, tape drives, flash memory, random-access memory, read-only memory, EEPROM storage, in-memory databases like SAP HANA, and so on, as well as any combination thereof. Stored data may be formatted within data stores in one or more formats, such as flat text file storage, relational databases, non-relational databases, XML, comma-separated values, Microsoft Excel files, or any other format known to those of ordinary skill in the art, as well as any combination thereof as is appropriate for the particular use. Data stores may provide various forms of access to the stored data, such as by file system access, network access, a SQL protocol (e.g., ODBC), HTTP, FTP, NES, CIFS, and so on, as well as any combination thereof.

According to various embodiments, client device 110 is configured to access DBMS 150 via management server 130. In various embodiments, DMBS 150 is configured to maintain a database schema. As will be described in further detail below, database schema 180 is configured to maintain a plurality of identifiers associated with specific categories of records. For example, database schema may be arranged to maintain identifiers in columns within DBMS 150 associated with auction and bidding information. In this aspect, identifiers refer to specific information pertaining to the categories described above. Database schema 180 within DMBS 150 may be arranged or organized in any suitable manner within the system. Although the above described examples identify categorical identifiers, any number of suitable identifiers may be used to maintain records associated with the system, described herein. In addition, a database schema may contain additional categories and identifiers not described above for maintaining record data in system 100. The database can also provide statistics and marketing information associated with users of system 100.

The database schema described above advantageously organizes identifiers in a way that permits the system to operate more efficiently. In some embodiments, categories of identifiers in the database schema increase efficiency by grouping identifiers with an associated management model of management server 130.

In various embodiments, management server 130 includes computing components configured to store, maintain, and generate data and software instructions. For example, management server 130 may include or have access to one or more processors 24, one or more servers (not shown) and tangible, non-transitory memory devices (e.g., local data store (in addition to DBMS 150)) for storing software or code for execution and/or additional data stores. Servers may include one or more computing devices configured to execute software instructions stored on to perform one or more processes in accordance with various embodiments. In some embodiments, DBMS 150 includes a server that executes software instructions to perform operations that provide information to at least one other component of computing environment 100, for example providing data to another data store or to third party recipients (e.g., banking systems, third party vendors, information gathering institutions, etc.) through a network, such as a communication network 142.

Management server 130 may be configured to provide one or more websites, digital portals, or any other suitable service that is configured to perform various functions of management server 130 components. In some embodiments, management server 130 maintains application programming interfaces (APIs) through which the functionality and services provided by server 130 may be accessed through one or more application, programs executed by a client device 110. In various embodiments, management server 130 may provide information to software application(s) on client device 110 for display on a graphical user interface 168.

In some embodiments, management server 130 provides information to client device 110 (e.g., through the API associated with the executed application program). Client device 110 presents portions of the information to corresponding users through a corresponding respective graphical user interface 168 or webpage.

In various embodiments, management server 130 is configured to provide or receive information associated with services provided by management server 130 to client device 110. For example, client device 110 may receive information via communication network 142, and store portions of the information in a locally accessible store device and/or network-accessible storage devices and data stores (e.g., cloud-based storage). For example, client device 110 executes stored instructions (e.g., an application program, a web browser, and/or a mobile application) to process portions of stored data and render portions of the stored data for presentation to the respective user or users. Management server 130 may include additional servers (not shown) which may be incorporated as a corresponding node in a distributed network or as a corresponding networked server in a cloud-computing environment. Furthermore, servers may communicate via communication network 142 with one or more additional servers (not shown), that may facilitate the distribution of processes for parallel execution by the additional servers.

### Auction Process Management

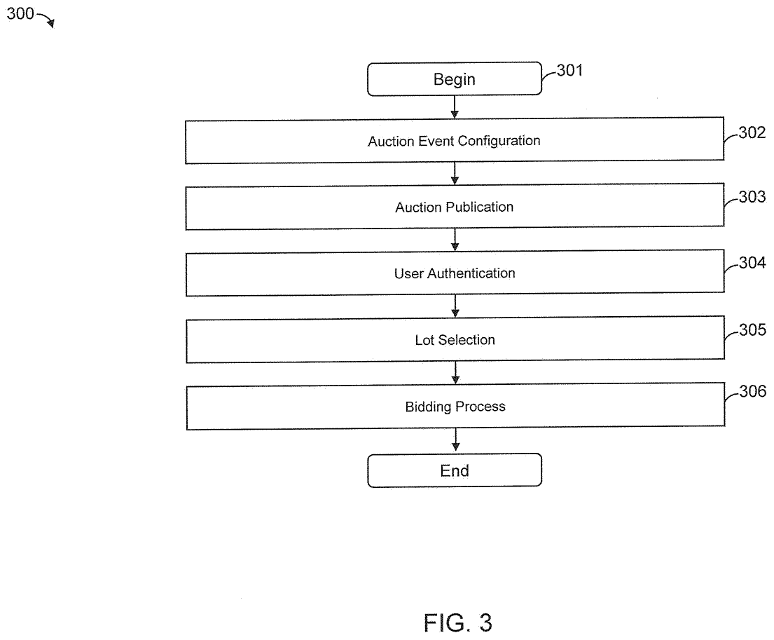

FIG. 3 is a flow diagram illustrating an example bidding process 300 in accordance with some embodiments of the present disclosure. In various embodiments, system 100 is configured to generate, authenticate and administer an auction in accordance with process 300. At 302, system 100 permits configuring an auction event by an administrative user on client device 110. in various embodiments, client device 110 is configured to provide an administrator interface as will be described in further detail below. In some embodiments, administrative service module 134 is configure to provide administrator interface on client device 110 via communication network 142. In this embodiment, user management 135 may authenticate a particular user as an administrator via login credentials. In various embodiments, configuring an auction includes determining settings associated with the title of the auction, type of auction, entry of lots for the auction, estimates for lots, permitted bidding increments, scheduling information, minimum lowest bid and/or any additional auction configuration information as would be understood to one of ordinary skill in the art. A lot refers to either an individual object or a group of objects that are offered for sale at an auction as a single unit.

At 303, system 100 is configured to publish the auction following configuration of the auction at 302. In various embodiments, publishing the auction places the auction in a ready state pending the start date identified by the administrator at step 302. In some embodiments, a published auction is viewable to users of system 100 via client devices 110. In some embodiments, user activity module 132 is configured to notify actively (e.g., notification pop-up, email, text message, etc.) and/or passively (e.g., searchable interface, auction lot listings, etc.) that an auction has been published. In various embodiments, a user of client device 110 has a profile associated with a user's credentials for gaining access to the system. In some embodiments, a user's profile maintains information about the user for associating a published auction lot to a user. In this embodiment, a respective user may receive publication information about a published auction lot based on the respective user profile information. In this example, not all users of system 100 will receive published auction lot information. Profile information used for associating an auction lot with a user profile may include preferences, buying history, search profiles, etc. One of ordinary skill in the art would know that a variety of information may be used to associate a published auction with a user profile. In various embodiments, user activity module 132 and user management module 135 may identify user profile information for associating a published auction with a respective user profile.

At step 304, according to various embodiments, a user of system 100 enters their credentials associated with a user profile and logs in via client device 110. In this embodiment, user management module 135 received user credential information via client device 110 across communication network 142. in some embodiments, authentication engine 137 facilities user authentication in system 100. As previously discussed above, client device 110 may be a webpage or portal for entering login information to system 100. In some embodiments, authentication engine 137 verifies user profile information stored on DBMS 150 via database connection interface 143.

At step 305, a user selects the auction lot they would like to bid on from the available auction lots published in system 100. In various embodiments, the lot selection associates a user profile with a published auction.

At step 306, the user begins the bidding process. In various embodiments, users bid on lots published in system 100 via respective client devices 110. In various embodiments, once a user bids, the querying for bidding is routed through an API to system 100. In various embodiments, system 100 writes the bid to DMBS 150 via database connection interface 143. In various embodiments, system 100 converts the bids made by users into an event, In various embodiments, the event is processed by a real-time data analytics tool such as Amazon Kinesis™. In this embodiment, the event representing a user bid is parsed and readied by user activity service module 132, which sends a bid received email notification or an indication that the bid submitted was outbid by another user, to the user client device 110 via communication network 142. In various embodiments, auction service module 131 determines which bid is the leading bid in an auction and is responsible for determining the winner of the lot based on auction engine logic module 133 of system 100.

In some embodiments, system 100 is configured to close an auction using a pressure sensitive gavel. According to various embodiments, live auction systems currently require a “bid clerk” or similar assistant in the auction room to close each lot during a live auction simultaneously with the auctioneer hammering their gavel. Due to the inherent discrepancy between when the auctioneer brings down the gavel and when this bid clerk takes whatever action necessary to close the lot in the auction system, it is possible for online bids to be placed during this interim period. In various embodiments, in order to reduce this chance for missed last-minute online bids, which cause client confusion and internal delays, system 100 is configured to communicate with a pressure-sensitive gavel pad, wherein the auctioneer hammering the gavel pad initiates a signal to the auction system to close the lot and removes the necessity for the clerk to perform a corresponding action.

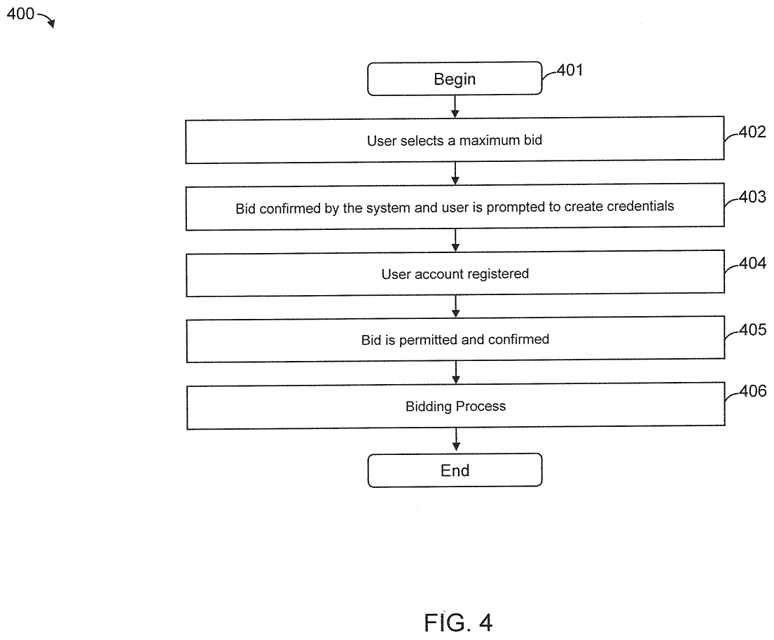

FIG. 4 is a flow diagram illustrating an example user bidding process 400 in accordance with some embodiments of the present disclosure. At 402, to bid in the auction, you can either place a bid as the next bid or select a maximum bid amount that system 100 will execute on your behalf when competing bids are placed.

In reference to FIG. 4 at 402, in various embodiments, a user may select a maximum bid, in this example, a maximum bid is the highest amount you would like to bid on the lot. In some embodiments, system 100 is configured to automatically place incremental bids on a user's behalf as much as is required to ensure the user remains the highest bidder, up to the respective user's maximum bid. In various embodiments, system 100 will execute bids beginning at the lowest increment. In some embodiments, system 100 is configured to permit the user to select the bid increment associated with a maximum bid. In various embodiments, system 100 is configured to notify the user via email, push notification, or other means when a maximum bid is outbid by another user. In various embodiments, when two maximum bids are identical, the bid that was entered in system 100 first will have priority.

In reference to FIG. 4 at 403, once a user's bid is entered into system 100, it must be confirmed and at that time a prompt for creating user login credentials will be available on via client device 110. At 404, system 100 is configured to create or register a user account associated with a respective user. In various embodiments, at 405, the bid will be permitted to be confirmed following registration of a user account with system 100.

In various embodiments, on the final day of the sale, lots will close in predetermined increments (i.e., 1 minute, etc.). In some embodiments, when a bid is placed in the last predetermined timeframe as identified by an administrator associated with configuring the auction event, the bidding will be extended for a further predetermined time to permit additional bidding. For example, if a bid is placed in the last 5 minutes of a lot closing, bidding will be extended for a further 5 minutes to allow time for interested bidders to continue bidding. In various embodiments, if the end time of one lot is extended, all other lots will continue as scheduled. More specifically, one lot will not affect the timing of another lot.

In various embodiments, system 100 is configured to permit a user to place a quick bid. in this embodiment, a bid can be made by swiping a quick bid button on an interface associated with client device 110. In some embodiments, pressing the quick bid button twice (i.e., “double-tapping”) or pressing the quick bid button once to initiate, and again to confirm, will place a bid at the next increment.

In various embodiments, system 100 is configured to provide real-time multimedia information associated with the live in-house and online auction to users. In this manner, video, audio and/or interface information is integrated via an interface at client device 110 for the auction to permit enhanced user interaction and dynamic updates of the auction event.

### Auction Bid Optionality

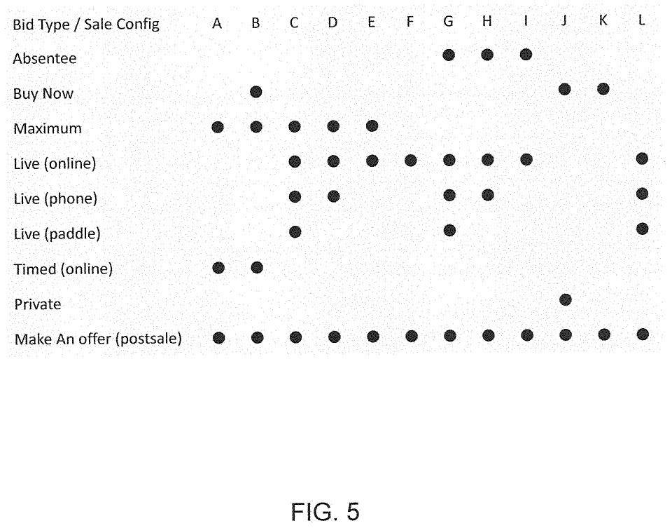

FIG. 5 illustrates an example auction engine logic for supporting bid type optionality in accordance with some embodiments of the present disclosure. As previously disclosed, embodiments described above may be successfully integrated in various auction types. For example, auction engine logic module 133 of system 100 is configured to support bid type optionality, which is illustrated in FIG. 5. In FIG. 5, bid types are listed on the Y-Axis, and the supporting sale configurations are listed on the X-Axis. FIG. 5 advantageously describes the bid type combinations possible within any given sale, according to various embodiments.

In reference to FIG. 5, an “absentee” bid type describes that a user can submit a non-competitive maximum bid amount prior to sale, and the auctioneer will place bids on behalf of the user. A “buy now” bid type presents the user with the option to purchase a lot for the requested amount. As shown in FIG. 5, the “buy now” bid type is only available in three different sale configurations (e.g., sale configurations B, J, and K). In this embodiment, sale configuration B describes that a user will interface with a timed auction, and for a predetermined duration of time, a “buy now” option will be available within the auction, where a user can purchase the lot for a set price. Sale configuration J describes that a user will be provided private access to an online auction experience, wherein the user can purchase the lot for the requested amount. Sale configuration K describes that any user can enter a marketplace, where a user can purchase the lot for a set price.

In further reference to FIG. 5, a maximum or competitive bid is similar to the previously described maximum bid. In various embodiments, a maximum bid may be made in sale configurations C, D, and E associated with a live auction and sale configurations A and B associated with an online auction. In various embodiments, sale configurations C, L), and E describe a standard live auction with the capability of submitting a maximum bid prior to the live in-room auction opening. Sale configurations A and B describe a standard timed auction with the capability of submitting a maximum bid throughout the duration of the time set for the online only auction.

In various embodiments, system 100 is configured to provide a live online bid type. In this embodiment, a user has the capability to participate and place bids within a traditional in-room live auction from any client device 110 via communication network 142. In various embodiments, system 100 is configured to provide a live phone bid type. A live phone bid type provides a user the capability to participate and place bids within a traditional in-room live auction from any client device. In this embodiment, a user can pre-select lots prior to the live auction start time, and indicate they want to bid on lots over the phone with a representative. Auction engine logic 133 determines the time in which the lots are to go on sale within the live auction and dynamically phones the user of a respective client device prior to the sale of a lot, at which time a user can speak with a representative while the property is up for sale and place bids. In some embodiments, the representative may be automated and use voice recognition software to receive bids.

In various embodiments, system 100 is configured to operate various processes via voice recognition software. For example, bidding information, auctioneer initiated actions, and clerking information may all be automatically identified using voice recognition software and keyed to trigger specific event processes without direct intervention. By way of example, instead of the bid clerk manually opening each lot by entering a numerical starting bid value and pressing the Enter key, system 100 is configured to automatically interpret the phrase “ . . . and I can open the bidding at X dollars,” where X is the starting bid, and input the spoken value as the starting bid, then open the lot for bidding, In an additional example, system 100 may send a “fair warning” message as soon as the auctioneer speaks the phrase, “fair warning” or “last chance”.

In various embodiments, system 100 is configured to provide a live paddle bid type. A live paddle bid type provides a user with the capability to participate and place bids within a traditional in-room live auction using a traditional paddle. In this embodiment, the user's bids will be captured via a bid clerk, and enter their bid within the bid clerk's interface, which dynamically and automatically records the bid by auction engine logic 133 of system 100. In some embodiments, system 100 is configured to receive bid indication via core motion activated paddles. In this embodiment, a motion activated paddle provides bi-directional communications with system 100 via communications network 142 and/or client device 110, wherein an accelerometer, or similar technology is used to dynamically place a paddle bid upon a user raising the device a certain height and/or width, to indicate a traditional in room bid. In various embodiments, a motion activated paddle is associated with a user profile on a respective user's client device. In some embodiments, a user of a motion activated paddle is assigned an account at the live auction such that online bids are received and recognized by system 100 in the same manner. Advantageously, this provides an equal and fair market in-room and online bidding opportunity to bid on lots for sale.

In reference to FIG. 5, system 100 is configured to provide a timed online bid type. A timed online bid type provides a user the capability to participate and place bids online, during the time period for which lots are available for bidding only online, which may be a contained time period into of itself, or in combination with which the auction moves into a live auction online in-room experience. In some embodiments, system 100 is configured to provide a private online bid type. In this embodiment, a user has the capability to participate and place bids within a controlled online private sale. These sales have a set duration of time, and the user interacts with the auction via client device 110. The user is able to provide a fixed or negotiated amount in order to secure the transaction. The first user to provide an acceptable fixed buy now amount will secure the transaction. In various embodiments, system 100 is configured to provide a make an offer bid type. A make sn offer bid type provides a method of identifying a user that might be interested in purchasing certain lots after auction that did not sell. In this embodiment, auction engine logic 133 facilitates and identifies user profile information for associating a lot with a user profile. In this embodiment, system 100 dynamically suggest lots to add to a user's collection based on the myriad of the user's profile for information, inclusive but not limited to artist, genre, style, price range, time period, etc.

In various embodiments, system 100 is configured to facilitate a soft reserve in to live auctions. For example, in live auctions with competitive bidding enabled, responsive bidding on behalf of the consignor up to the reserve could be disabled at a specified number of increments below the reserve value, This would allow the consignor and specialists to make an informed decision on whether to continue responsive bidding or hold the current bid at the current value based on logic expounded upon below. For certain lots, the consignor could be informed automatically via push/email notification and have full control over the decision to accept the bid at the current value or continue responsive bidding.

### Automated Live Auction

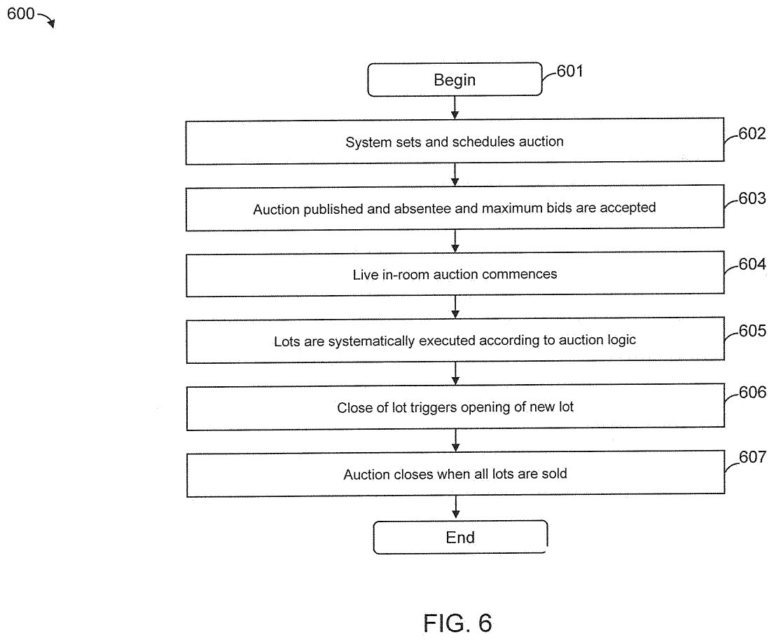

FIG. 6 is a flow diagram illustrating an automated auctioneer-less live auction process 600 in accordance with some embodiments of the present disclosure. In various embodiments, system 100 is configured to provide a fully automated live auction without human facilitation of the auction. At 602, system 100 sets and schedules an auction to an open or ready condition according to a predetermined time and date configured by an administrator via administrative service 134. For example, a user of client device 110 can configure an auction event to start at a given time and event date. At 603, the lot is published to users via client device 110 in accordance with embodiments described above prior to the live in-room bidding. In this embodiment, absentee and maximum bid types may be accepted prior to the live in-room auction predetermined time for the auction event. At 604, the live in-room auction will commence and a lot may be auctioned off and closed once the highest bid is met. In this example, system 100 is configured to recognize live in-room bids and online bids according to embodiments previously described above. At 605, auction engine logic 133 of system 100 coordinates lots in an event driven systematic manner according to a predetermined lot close time as configured by an administrator or at any predetermined time of no bid activity. According to some embodiments, if there is bidding activity, the lot will stay open for a predetermined amount of time. At 606, the close of one lot triggers the opening of a new lot for sale. At 607, once all lots have been sold, the auction will close. in various embodiments, the auctioneer does not accept or reject any bids that come in throughout the lifecycle of the auction. That said, the auctioneer can easily be involved in the live auction procedures, but more as a narrator in announcing the activity in the room and online as it happens and as lots go up for sale within the room. If it is determined that certain amount of intervention is required, system 100 is configured to allow for an auctioneer to extend the amount of time that a lot remains open, or pause the sale should an issue arise. According to some embodiments, the automated live auction would require any and all bids to be received in via client devices 110. In various embodiments, a user can swipe-to-bid on an interface provided via client device 110 online or at the live auction to indicate to system 100 that a bid event is occurring.

### Smart Auction House

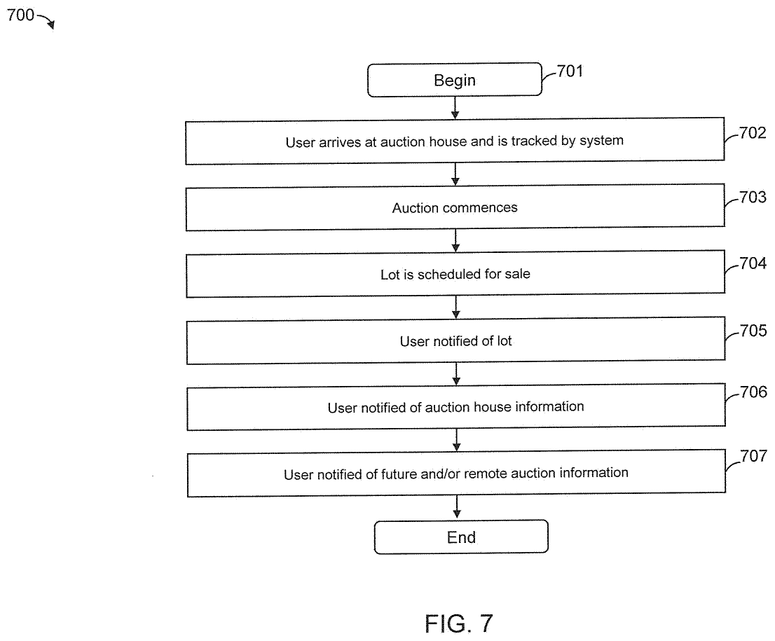

FIG. 7 is a flow diagram illustrating an example smart auction house process in accordance with some embodiments of the present disclosure. In various embodiments, system 100 is configured to provide wayfinding systems to coordinate user location information with in-room auction house events. Waylinding systems refer to information systems that guide people through a physical environment and enhance their understanding and experience of the physical space and information about the space. In reference to FIG. 7 at 702, as a user arrives at physical auction house, system 100 is configured to emit a notification to the client device 110 for a user. In this embodiment, system 100 may associate a client device 110 via a proximity location tracking mechanism. For example, Apple's iBeacon™ functionality permits communications from a client device associated with Apple's iOS™ software for location tracking of a user's client device 110. In another example, WiFi and/or Bluetooth technology permits location tracking of a client device via signal strength and triangulation. One of ordinary skill in the art would know that a user's client device location may be determined by a variety of methods in order to facilitate notifying the client device of events associated with the client device location.

At 703, the auction commences. At 704, a lot is scheduled according to system 100 for sale in accordance with embodiments described above. At 705, users are notified of lots, as determined by user activity module 132 and auction engine logic module 133 that associate a user profile with a lot for sale as described above. At 706, notifications are provided to the user of exhibitions of lots on display at the auction house. At 707, notifications are provided to the user of lots for sale and future events associated with an auction that may occur in the future and/or provide locations of other auctions within a predetermined distance of the auction house that would be associated with a lot and user profile information.

In various embodiments, system 100 is configured to coordinate a smart auction using artificial intelligence to determine when and where an item will be auctioned. In this embodiment, user activity module 132 and auction logic module 133 used information associated with previous auctions and user profile activity to determine the optimum time and location to sell a particular item. In various embodiments, this information is used to dynamically schedule an auction in system 100 using the embodiments described above. In some embodiments, a smart auction may be implemented, advertised, and coordinated selectively determined by auction engine logic module 133 to determine the best time and location to auction a particular item.

In connection with above embodiments, system 100 is configured to run using a portable component in any environment via communications network 142. In some embodiments, a live auction can be implemented in any location and receive bidding information via client devices, motion activated bidding paddle, or any other suitable means as described within this disclosure. In various embodiments, the auction can occur an in any location and receive bids from a plurality of online and live bidding sources without the presence of a traditional auctioneer or clerking host.

### Auctioneer Room View

in various embodiments, system 100 is configured to provide an augmented reality view on client device 110. In this embodiment, a display may be provided to the auctioneer indicating the streaming queue of bids, paddle numbers, and/or types of bids as they are placed. In various embodiments, a user of client device 110 may use an augmented reality view in the in-room live auction to indicate value and/or information relating to a specific lot or item. For example, the augmented reality view for client device 110 may include historical facts about the lot, previous owners, estimated value currently and over time, and/or any additional information that would be beneficial to be overlaid onto the client device during the auction event.

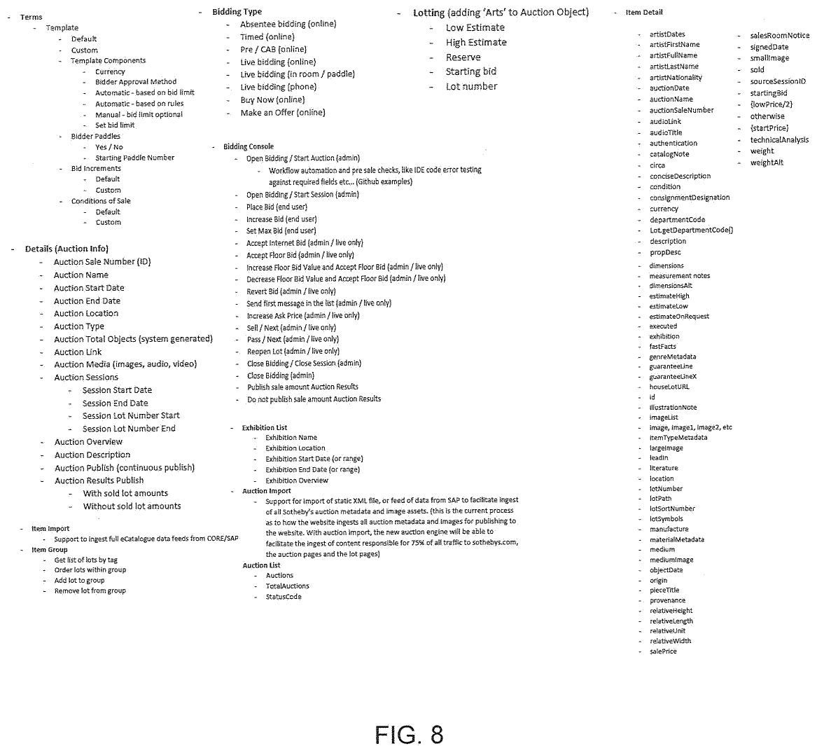

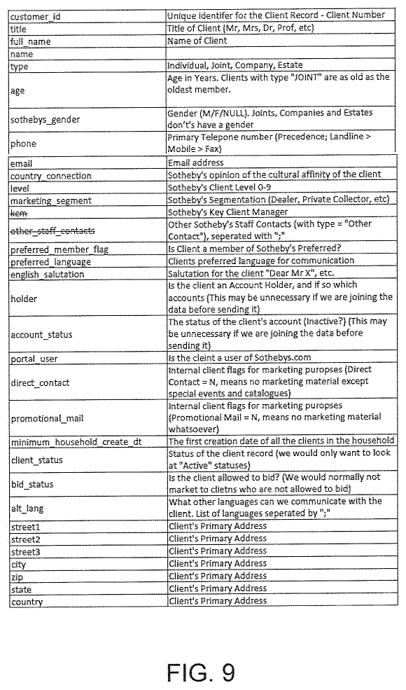

FIG. 8 illustrates example database tables in accordance with some embodiments of the present disclosure. FIG. 9 illustrates an example user/client information table in accordance with some embodiments of the present disclosure. According to various embodiments, various users have different functionality within system 100. For example, a super administrator user may have full system access to include ghosting any other user within the system. An auction house manager user will have unrestricted access to all activities within the auction house, to include configuring and running actions within the auction house, adding or editing lots for auction, and the capabilities to create and manage lower user levels. One of ordinary skill in the art will appreciate that system 100 can have a variety of user levels to facilitate and run an auction event within system 100.

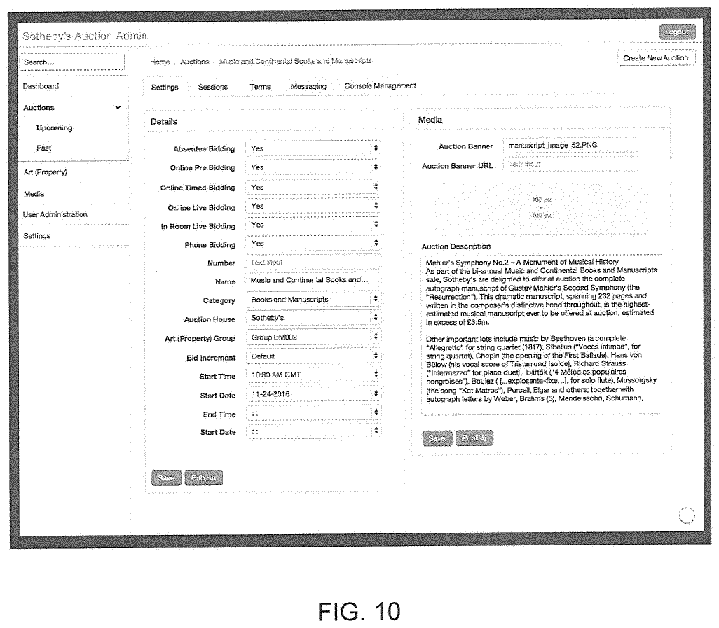

FIG. 10 is an example of an Auction Administrator interface in accordance with some embodiments of the present disclosure. In various embodiments, the auction administrator interface of system 1100 is provided for configuring, setting up, publishing and running an auction and primary attributes of an auction and lot detail pages.

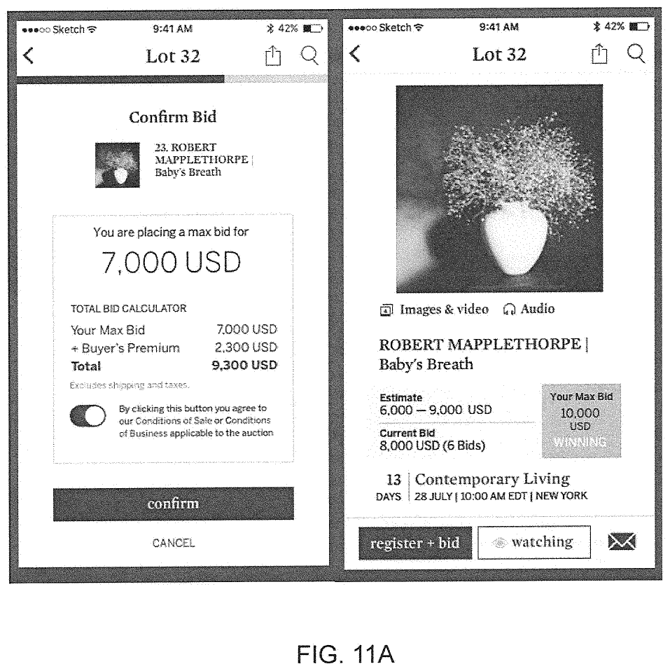

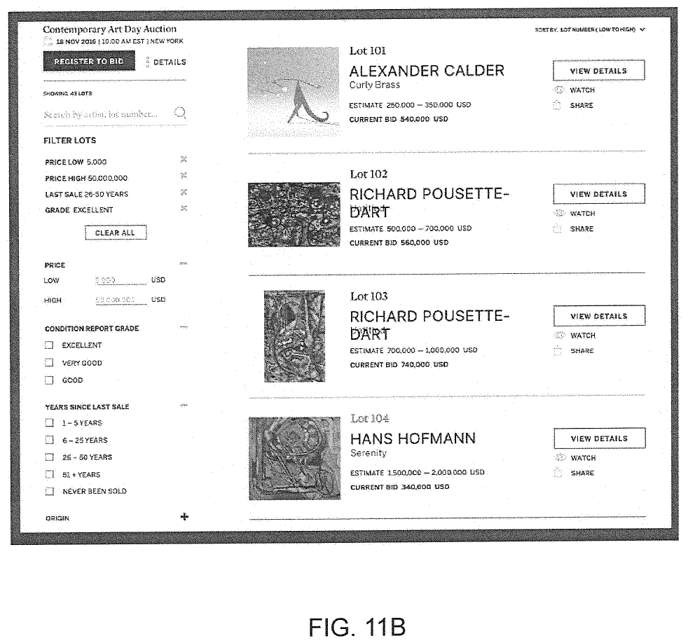

FIG. 11A is an example of a lot detail interface for a client device in accordance with some embodiments of the present disclosure. In various embodiments, a client device interface is provided to allow a user to register to bid, buy, and browse auctions and lots published within the auction engine. FIG. 11B is an example of an auction catalog interface in accordance with some embodiments of the present disclosure.

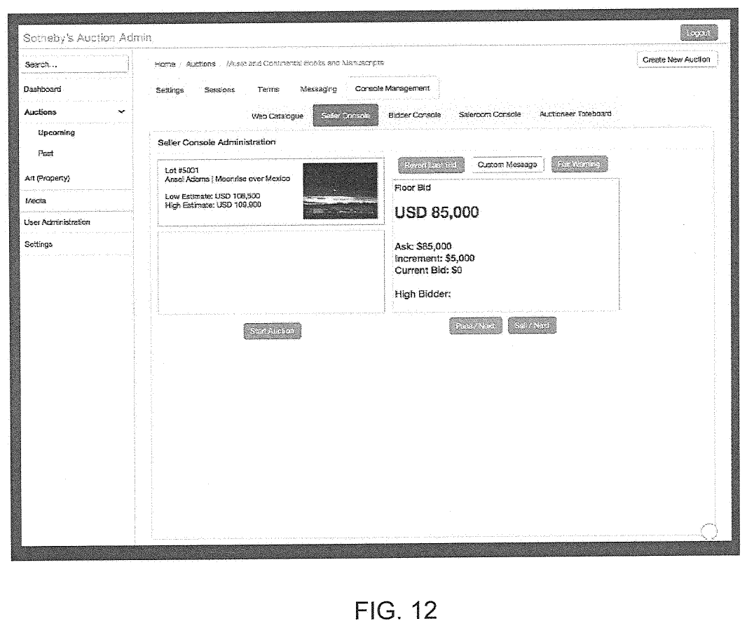

FIG. 12 is an example of a seller's console interface in accordance with some embodiments of the present disclosure, in various embodiments, system 100 is configured to provide a seller's console that will allow an auction member, typically the bid clerk, to moderate and administer inbound bids within the live bidding process. In this embodiment, the following functionality is highlighted within this internal facing web application;
Support Current Business Processes
Accept Internet Bid
Accept Floor Bid
Increase Floor Bid Value and Accept Floor Bid
Decrease Floor Bid Value and Accept Floor Bid
Revert Bid
Send first message in the list
Increase Ask Price
Ability to make lot sold
Ability to reopen lot
Voice activated controls
Bluetooth automated hammer
Ability to identify online user by paddle number

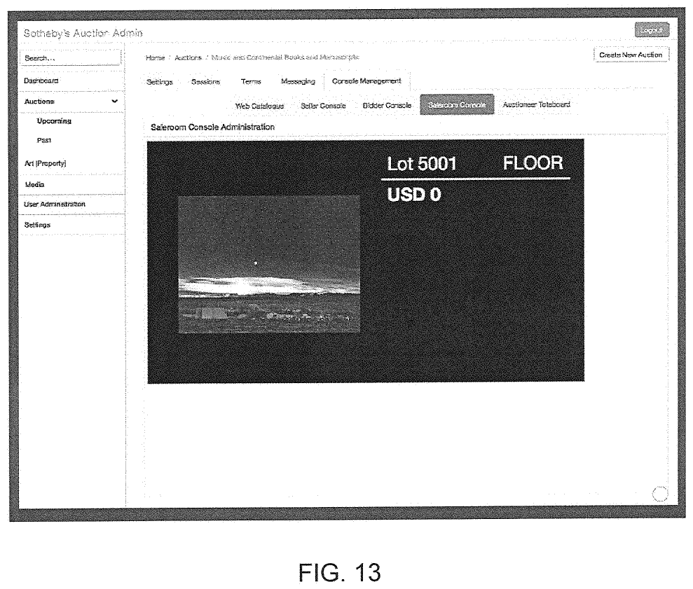

FIG. 13 is an example of a saleroom console interface in accordance with some embodiments of the present disclosure. In some embodiments, system 100 is configured to provide a saleroom console that will allow for the audience online and in room to be able to watch the bidding activity of the auction while it is taking place. Typically this console is located within the auction room and online displaying the following information via web application:
Currency
Lot Details
Totals

In various embodiments, system 100 is configured to provide an intelligence driven data analytics console client device. In this embodiment, instead of live video, a de-facto value of art over time is provided. in some embodiments, airline bidding for customer seating is provided using embodiments described above. In various embodiments, the above described disclosure provided for users of fantasy auctions the ability to make cash bidding against the over/under value of a lots for sale in the auction. In some embodiments, users can buy percentages of securities in an individual lot by dividing the lot into smaller shares such that more people can contribute to a joint ownership of the lot.

The present disclosure can be embodied in the form of methods and apparatus for practicing those methods. The present disclosure can also be embodied in the form of program code embodied in tangible media, such as secure digital (“SD”) cards, USB flash drives, diskettes, CD-ROMs, DVD-ROMs, Blu-ray disks, hard drives, or any other non-transitory machine-readable storage medium, wherein, when the program code is loaded into and executed by a machine, such as a computer, the machine becomes an apparatus for practicing the disclosure. The present disclosure can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the disclosure. When implemented on a general-purpose processor, the program code segments combine with the processor to provide a unique device that operates analogously to specific logic circuits,

It may be emphasized that the above-described embodiments, are merely possible examples of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any disclosure or of what may be claimed, but rather as descriptions of features that may be specific to particular embodiments of particular disclosures. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting, in certain combinations and even initially claimed as such, one or more features from a claimed combination may in some cases be excised from the combination, and the claimed combination may be directed to a subcombination or variation of a subcombination.

While various, embodiments have been described, it is to be understood that the embodiments described are illustrative only and that the scope of the subject matter is to be accorded a full range of equivalents, many variations and modifications naturally occurring to those of skill in the art from a perusal hereof.

What is claimed is:

1. A system, comprising:
a computing device configured to:
communicatively couple at least one client device that is accessible by a user having a respective user profile to a server hosting an auction;
receive a request to associate a user profile with the auction hosted by the server;
receive via the at least one client device bidding information associated with the auction, wherein the bidding information is dynamically displayed on the graphical user interface of the client device;
transmit bidding information from a respective user of the at least one client device associated with the auction: and
wherein the auction is configured to receive live bid information from bidders in an auction house.

2. The system of claim 1, wherein the computing device is further configured to notify the user about an auction based on user profile information.

3. The system of claim 2, wherein the notification to the user is further based on the at least one client device's proximity within an auction house.

4. The system of claim 1, wherein live bid information from bidders in an auction house is received via a client device.

5. The system of claim 1, wherein live bid information from bidders in an auction house is received via motion activated paddles.

6. The system of claim 1, wherein the computing device is further configured to receive bidding information before the auction has commenced.

7. A non-transitory computer readable medium having instructions stored thereon, wherein the instructions, when executed by the processor cause a device to perform operations comprising;
communicatively couple at least one client device that is accessible by a user having a respective user profile to a server hosting an auction;
receive a request to associate a user profile with the auction hosted by the server;
receive via the at least one client device bidding information associated with the auction, wherein the bidding information is dynamically displayed on the graphical user interface of the client device;
transmit bidding information from a respective user of the at least one client device associated with the auction; and
wherein the auction is configured to receive live bid information from bidders in an auction house without an operator.

8. The non-transitory computer readable medium of claim 7, wherein the computing device is further configured to notify the user about an auction based on user profile information.

9. The non-transitory computer readable medium of claim 8, wherein the notification to the user is further based on the at least one client device's proximity within an auction house.

10. The non-transitory computer readable medium of claim 7, wherein live bid information from bidders in an auction house is received via a client device.

11. The non-transitory computer readable medium of claim 7, wherein live bid information from bidders in an auction house is received via motion activated paddles.

12. The non-transitory computer readable medium of claim 7, wherein the instructions, when executed by the processor, cause the device to perform further operations comprising:
receiving bidding information before the auction has commenced.

13. A method, comprising;
communicatively coupling at least one client device that is accessible by a user having a respective user profile to a server hosting an auction;
receiving a request to associate a user profile with the auction hosted by the server;
receiving via the at least one client device bidding information associated with the auction, wherein the bidding information is dynamically displayed on the graphical user interface of the client device;
transmitting bidding information from a respective user of the at least one client device associated with the auction;
receiving live bid information from bidders in an auction house; and
integrating live hid information and bidding information from the at least one client device into the auction automatically.

14. The method of claim 13, wherein the computing device is further configured to notify the user about an auction based on user profile information

15. The method of claim 14, wherein the notification to the user is further based on the at least one client device's proximity within an auction house.

16. The method of claim 13, wherein live bid information from bidders in an auction house is received via a client device.

17. The method of claim 13, wherein live bid information from bidders in an auction house is received via motion activated paddles.

18. The method of claim 13, further comprising the steps of receiving bidding information before the auction has commenced.

19. The method of claim 13, further comprising the steps of ending the auction at a predetermined time identified during configuration of the auction.

20. The method of claim 19, wherein the auction may be extended based on bidding information.
